(19) United States
(12) Patent Application Publication
(10) Pub. No.: US 2015/0288927 A1
(43) Pub. Date: Oct. 8, 2015

(54) Interactive Two-Way Live Video Communication Platform and Systems and Methods Thereof

(71) Applicant: LI3 Technology Inc., Miami Beach, FL (US)

(72) Inventors: Sam S. Haginas, Miami Beach, FL (US); Beau C. Haginas, Miami Beach, FL (US)

(21) Appl. No.: 14/680,858

(22) Filed: Apr. 7, 2015

Related U.S. Application Data
(60) Provisional application No. 61/976,226, filed on Apr. 7, 2014.

(51) Int. Cl. H04N 7/15; H04N 7/14

(52) U.S. Cl. CPC H04N 7/155; H04N 7/147; H04N 7/142

(57) ABSTRACT

A system for providing interactive live communication between at least two users remotely situated from each other, wherein each user has an executing multimedia device and a communication platform application stored in the executing multimedia device and has a graphical user-interface through which users carry out all user-performed operations. Over a network interface, the platform application receives live video and audio data of a live event conducted by a first user and outputs in real time the received video and audio data to the first and a second user, transmits live video and audio data comprising the second user's input and outputs in real time the transmitted video and audio data to the two users thereby establishing live two-way interactive communication between the two users, and displays during the live event to at least the second user, at least one item associated with the content of the live event.

### CROSS-REFERENCE TO RELATED APPLICATIONS

This application claims the priority, under 35 U.S.C. §119, of U.S. Provisional Patent Application Ser. No. 61/976,226, filed on Apr. 7, 2014, the entire disclosure of which is hereby incorporated herein by reference in its entirety.

### FIELD OF THE INVENTION

The present invention lies in the field of interactive visual and audio platforms. Specifically, the present invention provides an interactive two-way live video communication platform. Using the live video platform in connection with an interactive multimedia device, users can interact with one another from different locations around the world. As a result, the live video communication platform can be advantageously used to conduct live interactions between users over streaming audio and video during live events in order to create a unique experience. For example, using the live video communication platform, spectators, fans, and other participants of a sports event, music concert, or other type of entertainment event can interact with one another in real time during the event. In another example, the live video communication platform can be used to connect professionals of various industries with their respective clients anywhere in the world and to conduct live interactions that are especially important to the efficacy of the services provided by these professionals (e.g., educational teaching, physical fitness training, legal consulting, etc.) In one illustrative example that is discussed in detail below, the live video communication platform can be utilized by health, fitness, wellness and sports professionals to provide live training and/or teaching sessions with clients over a television.

In addition, as also described in detail below, specific aspects of the live video communication platform function as an e-commerce platform that brings services and products to consumers while watching or participating in a live event.

The live video communication platform connects users to live events to produce interactive experiences, promote increased viewership through engagement, and convey interactive e-commerce opportunities.

Furthermore, the live video communication platform, through strategic partnerships with other web or mobile application developers, may act as a unique gateway to various pre-existing or customizable applications that may be interfaced and or otherwise specially created for inclusion into the live video communication platform such that users can benefit from the services provided by those applications in conjunction with the core interactive features of the live video communication platform.

### BACKGROUND OF THE INVENTION

The following description is applicable to any industry that can benefit from a live video communication platform that allows users to conduct live interactions with each other without any geographical limitations and increases a user's participation choices. Such industries include, for example, sports, film, music, dance, and other lyrical entertainment industries, as well as industries in which professionals routinely or necessarily conduct live interactions with clients, such as in the medical or legal professions and in educational instruction in a wide variety of disciplines (e.g., how to play a musical instrument, speak a foreign language, or perform a culinary task). In the present disclosure, particular concentration is placed on certain industries that can uniquely benefit from the live video communication platform of the present invention to provide illustrative examples. However, the present invention is not intended to be limited to any one specific industry.

For example, with respect to the health and fitness industry, it is widely known that recorded video content in DVD or other media formats and Internet-based streaming onto the television through a computing device are the primary methods for in-home education and training. These methods generally provide consumers a more affordable option, greater time flexibility, and more privacy in comparison to attending scheduled live, in-person sessions. However, as clearly evidenced by the growing obesity and health crisis facing the current population, these methods have not truly been an effective solution for providing permanent results. While many consumers have good intentions of committing to a health regimen when purchasing instructional pre-recorded materials, there is no accountability, sense of urgency or external motivation to complete these programs and, therefore, these programs are oftentimes abandoned not long after they are started and yield temporary results, if any.

Due to the vast technological advances in network communications and changing consumer behaviors, there are a number of live online video services that currently exist and attempt to connect consumers with industry professionals in real time. However, these services are restricted to traditional methods of using a laptop or a desktop computer and a webcam to host video training sessions and, therefore, are limited in screen viewing size. In addition, the environment in which these hardware components are typically set up is not conducive to a productive training or teaching experience. Furthermore, most of these existing live online services are one-dimensional in that the program or service offered presents only the training methods of the creator of that particular program or service and does not provide the consumer with a freedom of choice or selection between different methods. While some of these existing live online services do provide an expanded offering of service categories, the professionals associated with these services are not pre-approved or screened and may not be the most qualified to dispense such advice in that field.

Accordingly, a need exists to overcome the limitations discussed above.

### SUMMARY OF THE INVENTION

The present invention comprises a socially-minded or socially-connected interactive live video communication platform and systems and methods thereof that overcome the hereinafore-mentioned disadvantages of the heretofore-known devices and methods of this general type. Specifically, the present invention seeks to provide an effective method for engaging in interactive two-way live video communication during live broadcasted events and for training, teaching, and consulting with a chosen, and perhaps an elite level, professional across any interactive multimedia device by using an innovative software application and hardware system.

As mentioned above, the present disclosure focuses on specific industry examples as being illustrative of how the interactive live video communication platform of the present invention can be utilized in a particularly revolutionary way. For example, in the health and fitness arena, professionals in that field can conduct live training experiences with participants across the interactive live video platform using an interactive multimedia device. Therefore, participants can attend live training sessions from wherever they may be, including in the comfort of their own homes. As a result, users can engage live professionals in paid and scheduled training sessions to more effectively manage a healthy lifestyle and to determine the path to healthier choices that best suits that particular user with a greater level of self-accountability and consistency that is encouraged by the live, in-person interaction. The live video platform provides a database of the professional profiles of top health and fitness experts (e.g., personal fitness trainers, performance coaches, nutritionists, dieticians, life coaches, yoga instructors, etc.) such that a user can search or browse through the profiles to learn about and find a health or fitness expert for assistance. In addition, users can shop for related or recommended health and/or fitness products over the interactive live video communication platform. Because the live video communication platform is accessible to the masses of the population, positive results and a permanent lifestyle change are more readily possible on a large scale. Users have direct access to the highest level of knowledge and training such that health and wellness is no longer a luxurious amenity that is only available for those who can afford it. Furthermore, because users can engage the professional of their choice in the privacy and comfort of their chosen environment, the fear and concern of judgment and intimidation from others and the need to commute and endure the traditional costs of participating in group activities are significantly reduced or eliminated.

Professionals that participate in the interactive live video communication platform of the present invention may be required to pass a rigorous application process that may include a critique of the education, certification(s), and overall brand image of the professional.

From the viewpoint of the health or fitness professional, the access and connectivity provided by the live video communication platform allows the professional to achieve a higher level of efficiency and financial gain in being able to train multiple clients at once in a way that was not previously possible due to geographical and financial constraints. These professionals are no longer geographically restricted to their physical location and, as a result, their reach is exponentially broadened. In addition, the present invention uniquely allows professionals to capitalize on their respective brands. Using the live video communication platform, a professional can create a customized profile and utilize it as a powerful branding tool. The profile allows professionals to converge their entire digital footprint into a single profile page where they can boast their achievements, offer video services and sell recommended products. In essence, the professional profile functions as a mini website brand page. Other features of the live video platform of the present invention allow professionals to manage scheduling of sessions, perform accounting tasks, and generate detailed analytics that quantify the value of their business for existing and prospective sponsors. Accordingly, the dynamic video hosting and personalized e-commerce solution provided by the interactive live video platform of the present invention is truly unique.

With the foregoing and other objects in view, there is provided, a system and methods for providing interactive live communication between at least two users remotely situated from each other, comprising at least one server having at least one processor and at least one computer-readable storage medium, the at least one computer-readable storage medium having computer program instructions configured to be executed by the at least one processor of the server, a network communicatively coupled to the at least one server, at least a first user and a second user that is remotely situated from the first user, each user having an executing multimedia device having at least one computer-readable storage medium, a communication platform application stored in the at least one computer-readable storage medium, the communication platform application comprising a graphical user-interface through which users carry out all user-performed operations, at least one processor communicatively coupled to the at least one computer-readable storage medium and configured to run the communication platform application, at least one input device that captures in real time live video and audio data from the environment local to the user, a network interface communicatively coupled to the network and that receives in real time from the network live video and audio data from at least one remote location, and at least one output device that displays the graphical user-interface and outputs to the user, in real time and within the graphical user-interface, the live video and audio data received from the network, and wherein the communication platform application receives via the network interface live video and audio data of a live event being conducted by the first user and, using the at least one output device, outputs in real time the received video and audio data to the first and second users, transmits via the network interface live video and audio data comprising the second user's input in response to the live event and captured by the at least one input device and, using the at least one output device, outputs in real time the transmitted video and audio data to the first and second users to thereby establish live two-way interactive communication between at least the first and second users, and using the graphical user-interface, displays during the live event to at least the second user, at least one item associated with the content of the live event.

In accordance with another mode of the invention, the executing multimedia device is an interactive set-top box that is electrically coupled to a television and comprises at least one high-definition camera to capture video data from the surrounding environment, at least one microphone to capture audio data from the surrounding environment, at least one video output electrically connected to the television to output video data, and at least one audio output electrically connected to at least one loudspeaker to output audio data.

In accordance with a further mode of the invention, the executing multimedia device is a personal computer comprising at least one high-definition camera to capture video data from the surrounding environment, at least one microphone to capture audio data from the surrounding environment, a display screen to output video data, and at least one loudspeaker to output audio data.

In accordance with an added mode of the invention, the personal computer further comprises at least one video output configured to be electrically connected to a television to output video data and at least one audio output configured to be electrically connected to at least one external loudspeaker to output audio data.

In accordance with an additional mode of the invention, the executing multimedia device is a mobile device comprising at least one high-definition camera to capture video data from the surrounding environment, at least one microphone to capture audio data from the surrounding environment, a display screen to output video data, and at least one loudspeaker to output audio data.

In accordance with yet another mode of the invention, the mobile device further comprises at least one video output configured to be electrically connected to a television to output video data and at least one audio output configured to be electrically connected to at least one external loudspeaker to output audio data.

In accordance with yet a further mode of the invention, the network interface is communicatively coupled to the network using at least one wireless link.

In accordance with another mode of the invention, there is further provided at least one user remote control device communicatively coupled to the executing multimedia device and through which a user accesses, controls, and interacts with the communication platform application.

In accordance with a further mode of the invention, there is provided a plurality of additional users wherein each of the additional users is remotely situated from the first and second users and from each other, and the communication platform application of the executing multimedia device of each of the additional users receives via the network interface the live video and audio data of the live event being conducted by the first user and, using the at least one output device, outputs in real time the received video and audio data to the additional user, transmits via the network interface live video and audio data comprising the additional user's input in response to the live event and captured by the at least one input device and, using the at least one output device, outputs in real time the transmitted video and audio data to the first user and the additional user to thereby establish live two-way interactive communication between at least the first user and the additional user, and using the graphical user-interface, displays during the live event to at least the additional user, at least one item associated with the content of the live event.

In accordance with an added mode of the invention, there is provided a plurality of additional users wherein each of the additional users is remotely situated from the first and second users and from each other, the communication platform application of the executing multimedia device of each of the additional users receives via the network interface the live video and audio data of the live event being conducted by the first user and, using the at least one output device, outputs in real time the received video and audio data to the additional user, transmits via the network interface live video and audio data comprising the additional user's input in response to the live event and captured by the at least one input device and, using the at least one output device, outputs in real time the transmitted video and audio data to the first and second users and the plurality of additional users to thereby establish live multi-way interactive communication between the first and second users and the plurality of additional users, and using the graphical user-interface, displays during the live event to the second user and the plurality of additional users, at least one item associated with the content of the live event.

In accordance with an additional mode of the invention, the second user purchases access to the live event using the communication platform application.

In accordance with yet another mode of the invention, the at least one item associated with the content of the live event depicts a related product that can be purchased through the communication platform application.

In accordance with yet a further mode of the invention, the at least one item associated with the content of the live event is a text message from the first user.

In accordance with another mode of the invention, the at least one item associated with the content of the live event is an informative indication regarding the second user's input in response to the live event.

In accordance with yet another mode of the invention, the at least one item associated with the content of the live event is a playlist of music heard by the second user during the live event.

In accordance with yet a further mode of the invention, the first user is an industry professional, the live event is an instructional session conducted by the first user and comprises visual and auditory instruction, and the second user is an attendee of the instructional session.

In accordance with another mode of the invention, the first user is an industry professional, the live event is an instructional session conducted by the first user and comprises visual and auditory instruction, and the second user and the plurality of additional users are attendees of the instructional session.

In accordance with yet another mode of the invention, the communication platform application further comprises a search function whereby the second user can search for an industry professional that meets certain parameters that are specified by the second user using the graphical user-interface.

In accordance with yet a further mode of the invention, the communication platform application further comprises a professional profile that is associated with and customizable by the industry professional, contains informative and promotional materials about the industry professional, and is viewable by the second user through the graphical user-interface.

In accordance with another mode of the invention, the professional profile further comprises a function in which the second user can schedule an instructional session and a function in which the industry professional can promote or recommend one or more products related to the instructional session.

Although the present invention is illustrated and described herein as embodied in an interactive two-way live video communication platform and systems and methods thereof, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to further illustrate various embodiments and to explain various principles and advantages in accordance with the present invention. Advantages of embodiments of the present invention will be apparent from the following detailed description of the exemplary embodiments thereof, which description should be considered in conjunction with the accompanying drawings in which:

FIG. 1 is a perspective view from behind, depicting a user in a representative in-home setting and engaged in an interactive two-way live video fitness training session with a fitness professional using an exemplary embodiment of the live video communication platform of the present invention in connection with a display device and an interactive intelligent set-top box electrically connected to the display device and equipped with a high-definition camera;

FIG. 2 is a series of graphical illustrations of a display device screen depicting four exemplary embodiments of dynamic types of live video services provided by the live video communication platform of the present invention;

FIG. 3 is a schematic view of an introductory page of a graphical user interface in accordance with an exemplary embodiment of the live video communication platform of the present invention, depicting the 3-dimensional design and active functionality of the live video communication platform;

FIG. 4 is a perspective view from behind, depicting a user using browsing for a professional through an interactive super wall filtered search tool in accordance with an exemplary embodiment of the live video communication platform of the present invention, whereby the user is operating an exemplary embodiment of a dual-sided multimedia remote control device of the live video communication platform in order to navigate about the search tool;

FIG. 5 is a graphical illustration demonstrating how the live video communication platform of the present invention is designed to work in connection with any interactive multimedia device of a user's existing hardware that can be connected to and displayed on a television;

FIG. 6 is a schematic view of five different components of a professional profile that provide a combined functionality, in accordance with an exemplary embodiment of a graphical user interface of the live video communication platform of the present invention;

FIG. 7 is a schematic view of a service page of a professional profile, in accordance with an exemplary embodiment of a graphical user interface of the live video communication platform of the present invention; and

FIG. 8 is a high-level block diagram of a system in accordance with an exemplary embodiment of the present invention in which local and remote users are connected to and interacting through the interactive live video communication platform.

### DETAILED DESCRIPTION OF THE INVENTION

As required, detailed embodiments of the present invention are disclosed herein; however, it is to be understood that the disclosed embodiments are merely exemplary of the invention and can be embodied in various forms. Therefore, the specific structural and functional details that are disclosed herein are not to be interpreted as limiting, but merely as a basis for any claims and as a representative basis for teaching one skilled in the art to variously employ the present invention in virtually any appropriately detailed structure. Further, the terms and phrases that are used herein are not intended to be limiting; but rather, to provide an understandable description of the invention. While the specification may conclude with claims defining the features of the invention that are regarded to be novel, it is believed that the invention will be better understood from a consideration of the following description in conjunction with the drawing figures in which like reference numerals are carried forward.

### DEFINITIONS

Before the present invention is disclosed and described, it is to be understood that the terminology herein is not intended to be limiting and is only being used for the purpose of describing particular embodiments. Unless otherwise specified, all technological terms used herein have the same meaning as commonly understood by one of ordinary skill in the art to which the present invention belongs.

As used herein, the terms “a” or “an”, are defined as one or more than one. The term “plurality”, as used herein, is defined as two or more than two. The term “another”, as used herein, is defined as at least a second or more.

As used herein, the terms “including” and/or “having”, are defined as comprising (i.e., open language). The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, relational terms, such as first and second, may be used solely to distinguish one entity or action from another entity or action without necessarily requiring or implying any actual such relationship or order between such entities or actions.

As used herein, the term “coupled” is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

As used herein, the terms “component,” “system,” “database,” and “server” are intended to refer to a computer-related entity, either hardware, a combination of hardware and software, software, or software in execution. The terms “program,” “software,” “software application,” and the like as used herein, are defined as a sequence of instructions designed for execution on a computer system. In addition, a “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

As stated above, the following description of the functionality of the live video platform of the present invention is provided within the illustrative context of the health and fitness arena. However, the interactive live video platform of the present invention is readily adaptable to a wide range of fields and is in no way intended to be limited to one particular field.

System Components

As mentioned above, the interactive live video communication platform of the present invention comprises a software application that is preloaded or installed in an interactive multimedia device capable of executing the software application with memory and processing components of the device and displaying a graphical user interface of the live video communication platform to a user. Such devices may include, but are not limited to, mobile devices, tablets, personal computers (PCs), or any other type of computing device. The software application is compatible with all operating systems and devices. In addition, the interactive multimedia device must also be equipped with audio and video capture and audio and video signal input and output and must be able to transmit and receive data in real time across an Internet network in order to implement the live and interactive two-way communication that is essential to the live video communication platform of the present invention.

It is also envisioned that users can access the interactive live video communication platform using a web-based portal through a dedicated website that may be accessed using an Internet-accessible device (e.g., a desktop computer).

In an exemplary embodiment of the present invention, the software application of the live video communication platform is pre-programmed into the memory of an interactive intelligent set-top box that is electrically connected to a display device such as a conventional television. One archetypical example of an interactive set-top box that is capable of executing the software application is disclosed in U.S. patent application Ser. No. 14/245,687, which claims priority to both Chinese Utility Model Application No. 201320720306.5 and Chinese Design Patent Application No. 201330484967.8, which applications are incorporated herein in their entireties. The native software application of the live video communication platform may be stored in memory components and executed by microcontroller components that are internal to the interactive set-top box. The interactive set-top box is provided with hardware to capture and transmit audio and video input local to the device such as, for example, a high-sensitivity microphone and a high-definition video camera. In addition, the interactive set-top box is equipped with a network interface by which it may be electrically connected to an Internet network whereby it can receive live video and audio data from one or more remote locations. Further, the interactive set-top box is also equipped with control chip and audio processing components that in accordance with the interactive live video communication platform of the present invention, process the captured and received live video and audio data in such a manner that achieves a seamless live two-way interaction between a user that is local to the interactive set-top box and one or more users at remote locations. Also, the interactive set-top box outputs audio and video data to the local user through one or more loudspeakers and through the connected display device (e.g., television) in conjunction with a graphical user interface of the interactive live video communication platform of the present invention. The software application of the live video communication platform conducts real time audio and video communications between users over the Internet network using any suitable communications platform or implementation. For example, the WebRTC video technology provided by Google® can be used to power the real time communications of the platform.

In order for a user to perform input, navigation, and selection functions of the interactive live video communication platform of the present invention wherein the executing device is an interactive set-top box, the user may be provided with a user remote control device that allows the user to interact with the platform of the present invention and to control the interactive set-top box. In an exemplary embodiment of the present invention, the user remote control device is a wireless device that comprises a keyboard having alphanumerical and function keys, a mouse control, and a series of remote control buttons that perform a specific selection and/or control function. In addition, the interactive set-top box may also be configured to be controlled by any remote control, keyboard and/or mouse device that is Bluetooth® compatible. In other instances in which the executing device is another type of interactive multimedia computing device (e.g., a PC, mobile device or tablet), a user input and control device will typically already be built into the device and, therefore, a separate remote control will not be needed.

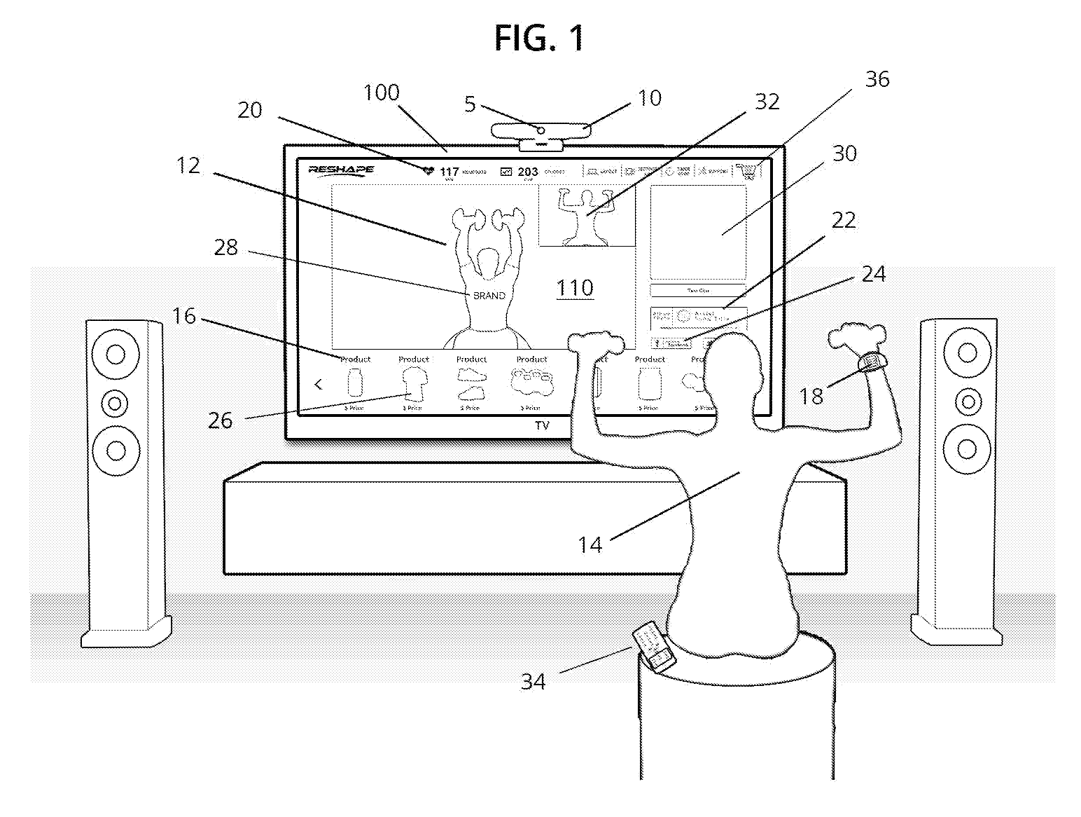

Referring now to the figures of the drawings in detail and first, particularly to FIG. 1, there is shown an exemplary embodiment of the interactive live video communication platform of the present invention in use by a user 14 in the home or living space of the user 14. In this exemplary embodiment, the software application of the live video communication platform is being implemented by an interactive set-top box 10 and high-definition camera 5 that is electrically connected to and mounted on top of a television 100. This particular set-up is for illustrative purposes only and is not intended to limit the system hardware to the exact display and executing devices shown in FIG. 1. Pictured on the screen of the television 100 is an exemplary embodiment of a graphical user interface 110 of the interactive live video communication platform of the present invention. The graphical user interface 110 is a user's window and gateway into the live video communication platform. All user-performed operations and all interactions between the users of the platform are done using the graphical user interface 110.

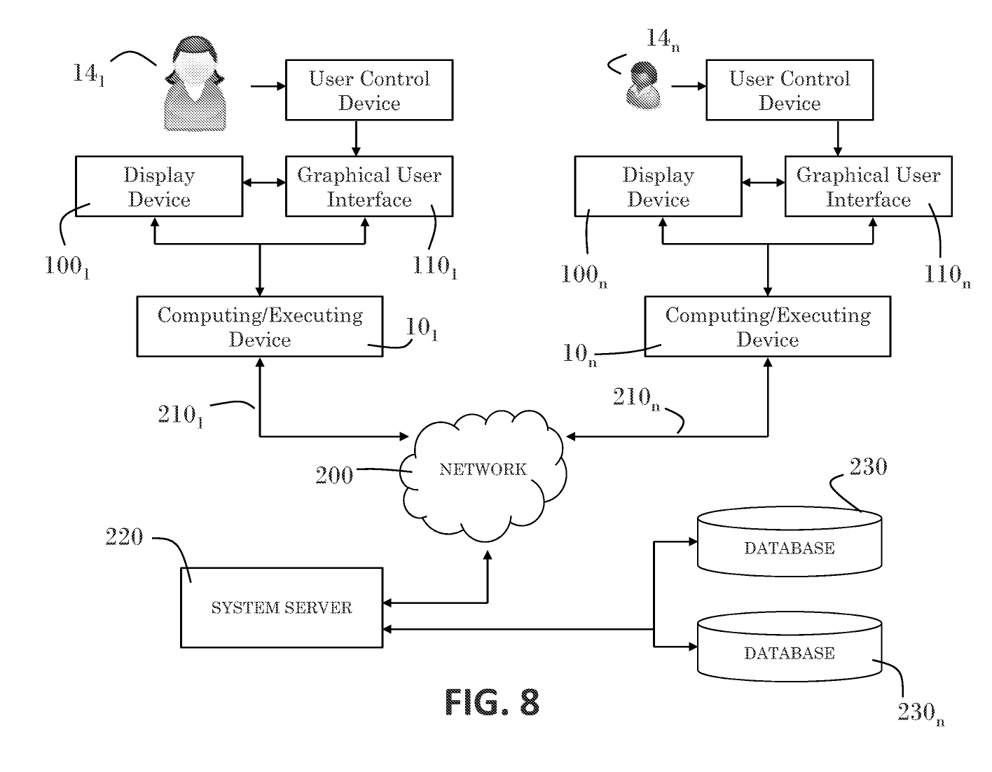

Turning to FIG. 8, there is shown a general overview of a system architecture of an exemplary embodiment of the present invention by which a local user 14₁ and one or more remote users 14ₙ two-way interact via the live video communication platform, whereby the subscript number “n” could be any number greater than 1. The executing multimedia devices 10₁, 10ₙ (whereby the subscript number “n” could be any number greater than 1) of users 14₁, 14ₙ communicate with one or more servers 220 using the wired or wireless connections 210₁, 210ₙ (whereby the subscript number “n” could be any number greater than 1) and network 200. Data is stored in one or more databases 230, 230ₙ (whereby the subscript number “n” could be any number greater than 1). Databases 230, 230ₙ may be accessed by servers 220. The processes described in this application may be implemented in general, multi-purpose, or single purpose processors. The functionality of the systems of the invention may be accomplished using any methods, processes, and applications known in the art.

Interactive Two-Way Live Video Communication Platform

Referring back to FIG. 1, user 14 is shown as being in the midst of engaging in a live session using the live video communication platform of the present invention.

a. Health and Physical Fitness Illustrative Example

In this example, the training session is being conducted by a fitness professional 12 who is in a location remote from user 14. By way of the interactive live video platform of the present invention, the user 14 is able to see and hear the fitness professional 12 through the graphical user interface 110 that is being displayed on the television 100 and through one or more loudspeakers of the interactive set-top box 10. The user 14 is following visual and auditory instruction from the fitness professional 12 in real time and a mirrored feedback of the user's own movements is captured by the high-definition camera 5 of the interactive set-top box 10 and shown to the user 14 in a video view 32 that is displayed in a picture-in-picture format in the upper right quadrant of the graphical user interface 110.

Several key inventive aspects of the interactive live video communication platform are illustrated in the exemplary embodiment shown in FIG. 1. For example, the user 14 is also wearing a monitoring device 18 on the wrist that is continuously uploading data pertaining to certain parameters of the user to the interactive live video communication platform using, for example, an application programming interface (API). This informative data sensed by the monitoring device 18 is reported to the user 14 in an “in session progress statistics” area 20 positioned near the top of the graphical user interface 110 such that the user 14 can track his or her progress in a statistical manner. Such data may include, but is not limited to, the user's heart rate, calories burned, intensity, amount of rest time, number of repetitions or steps, a distance measurement, and statistical goals.

In another example, at the bottom of the graphical user interface 110, a number of fitness-related products 16 are displayed to the user 14. These products 16 may be specifically recommended by the fitness professional 12 and pre-selected before the training session. These products 16 are available for purchase by the user 14 directly through the live video communication platform. To purchase a product 16, the user 14 selects the desired product using a user input and control device 34 (e.g., a user remote control device) and adds it to a shopping cart 36. To promote the products 16, the fitness professional 12 may reference the products during the live session. To further add to the e-commerce function of the interactive live video communication platform, FIG. 1 depicts the fitness professional 12 as wearing a particular branded t-shirt 28, which may also be made available for purchase by the user 14 (see product 26 in the line of products 16) in session or post session.

In an additional example, displayed in session or post session on the graphical user interface 110, are one or more buttons 24 that directly link the user to one or more social media accounts (e.g., Facebook®) in order for the user to share postings related to the session. For example, in a motivational manner, the user 14 may wish to post that he or she is participating in or has completed a fitness training session with fitness professional 12.

In a further example, a music player 22 may be provided by the interactive live video communication platform and displayed on the graphical user interface 110 as a tool used during a training session. The music player 22 may be an embedded player of a mainstream social music service (e.g., Spotify®) that is configured to play a playlist of music tracks that has been custom-selected pre-session by the fitness professional 12. The music player 22 may display the album artwork of the album from which the currently-playing track is a part of, as well as display the upcoming track title. In addition, an active social button that directly links the user 14 to his or her own account with the social music service may be displayed to the user 14 in order for the user to follow the same track playlist, share the track playlist, or post that he or she has listened to a track in the playlist.

Additionally, a session text chat and info box 30 is provided in, for example, the prominent area of the upper right corner of the graphical user interface 110, and allows the user 14 and the fitness professional 12 to exchange typed messages and to share files during the session, as well as log all activities that occur during the session. Such activities could include, but are not limited to, user actions such as muting audio or hiding video, information when users join, exit or are temporarily away from the session, audio track information of the current song playing in the music player, achievements or goals hit in, for example, the target heart rate or reps of a particular exercise as defined by the wearable monitoring device 18, and status events of file and/or screen sharing activities. This session text chat feature allows for a private communication between an attendee or a participant and the professional such that the text chat is not visible to the other attendees or participants. However, it is contemplated that in some types of sessions in which there are multiple attendees or participants (see e.g., the “broadcast” live video session described below) all participants are allowed to view the session chat feed and log.

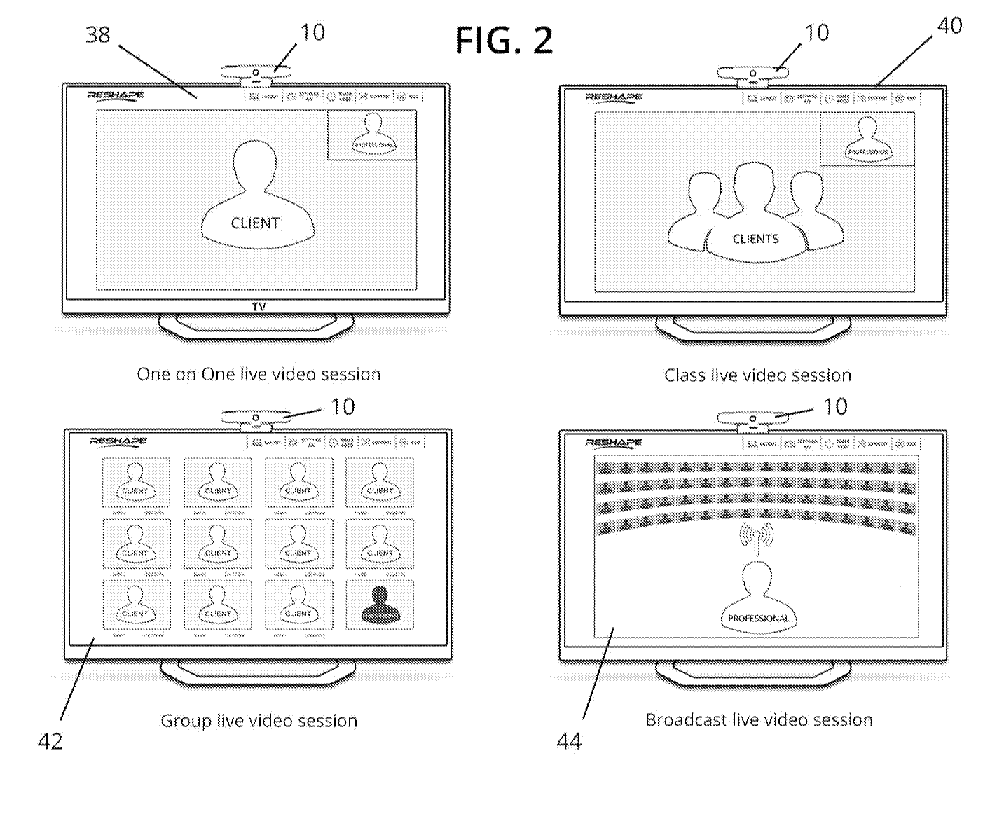

Referring now to FIG. 2, there is shown a series of graphical illustrations of a display device screen depicting four exemplary embodiments of dynamic types of live video sessions provided by the live video communication platform of the present invention. In the upper left corner of FIG. 2, a “one-on-one” live video session 38 is depicted from the vantage point of a professional whereby a live two-way video and audio communication is being conducted between the professional and only a single attendee. In the upper right corner of FIG. 2, there is shown, also from the vantage point of a professional, a “class” live video session 40 in which a live two-way video and audio communication is being engaged in by the professional and multiple attendees located in the same space and on the same video feed. This type of session allows multiple attendees to individually schedule and pay for an interactive session and yet, participate in the session together. In the lower left corner of FIG. 2, a “group” live video session 42 is depicted again from the vantage point of a professional whereby a live multi-way video and audio communication is being conducted between the professional and multiple attendees that are all separately located from each other and are all on separate video feeds. In this type of session, although each attendee will receive the video and audio feed of the professional conducting the session, each attendee is not be able to see or hear any of the other attendees. Also, the professional has the ability to manage the different video screens showing each attendee that is attending the session. For example, the professional can resize a particular attendee video screen, selectively mute a particular attendee, or end the session with a particular attendee while keeping the session active for all other attendees. In the lower right corner of FIG. 2, there is shown a “broadcast” live video session 44 in which a live one-way video and audio communication is conducted whereby a professional can broadcast audio and video to an unlimited number of attendees. However, the professional is unable to receive any audio or video from any of the attendees and communication from the attendees is restricted to only in-session typed messaging between all participants. These four different live video session types are merely a representative few of a number of different live video session types that may be implemented by the live video communication platform of the present invention. A number of other live video sessions types, each having their own specific communication features and parameters, are contemplated as being within the scope of the present invention.

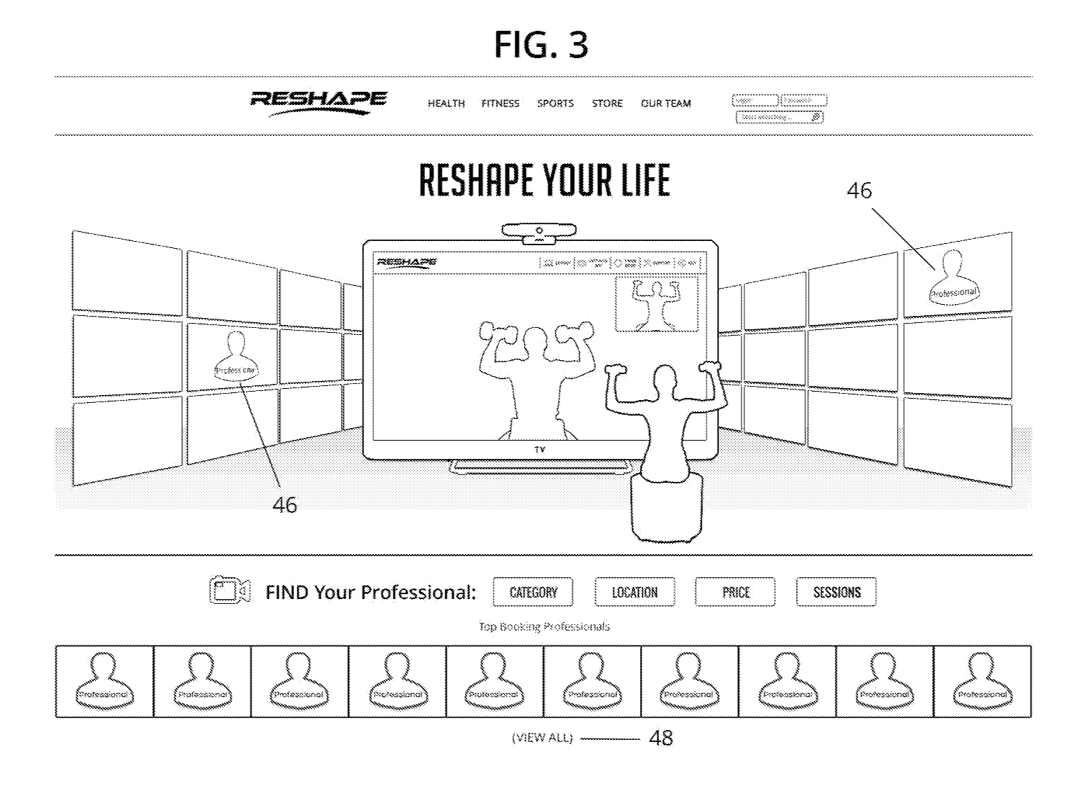

FIG. 3 depicts an exemplary embodiment of a “home page” of the graphical user interface 110, which is the introductory view that first appears in front of a user when accessing the platform software application. At the center of this home page depicts a mockup of a sample live video session environment on a display device. When the user clicks on the center mockup, an introduction video is played to the user. This introductory video may educate the user as to the functionality of the platform, may provide the user with a mock live session event, may be an inspirational message to the user, or may be an introduction by a specific professional that the user has preliminarily selected to learn more about. To begin using the interactive live video communication platform, the user may be prompted and required to create a registered user account in order to fully access the platform. In addition, a number of user-selectable main tabs (shown at the top of FIG. 3 as “Health,” “Fitness,” “Sports,” “Store,” and “Our Team”) on this home page may allow the user to quickly navigate to specific areas of the platform. For example, the “Store” tab takes a user directly to an online store that is a part of the platform of the present invention and carries, for example, nutrition and supplement products and functional fitness equipment and accessories.

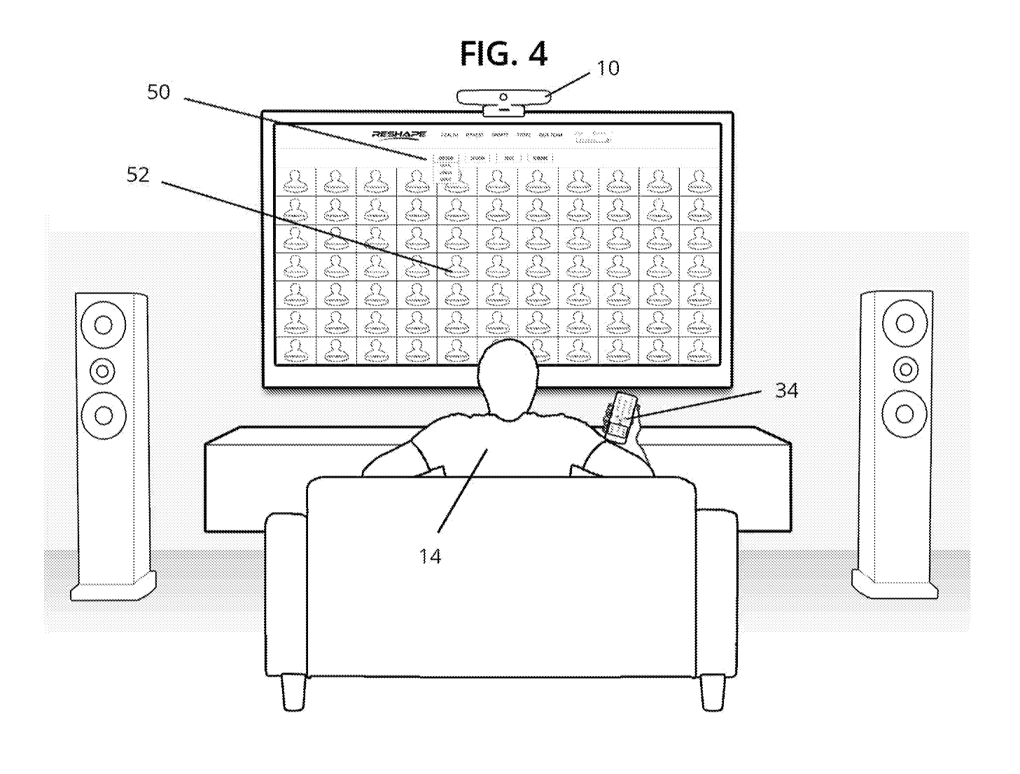

The main function of the home page is to allow a user to browse through or search for and select a professional to begin taking advantage of the education, training, and recommendations that a participating professional has to offer. A user is able to browse through the profiles of all participating professionals by selecting the “View All” option 48. The “View All” option 48 is an active link to a full screen profile super wall display, which is described further below and shown in close detail in FIG. 4. Alternatively, a powerful search tool is provided whereby a user can immediately narrow the field and search for one or more professionals that fall within specific user-defined parameters (e.g., by subject “category,” geographical “location,” “price” level, and type of “sessions” offered). At the bottom of the home page, a thumbnail reel may be provided to promote certain professionals, such as those participating professionals who have booked the most sessions through the platform. At each side of the central mockup is a uniquely designed 3-dimensional wall projection 46 of the thumbnails of various professional profiles. This 3-dimensional projection is a unique design and functionality of the platform of the present invention that was created using several programming languages and involving complex mathematical calculations to create an active skewed 3-dimensional perspective that resizes dynamically depending upon the screen size, resolution, or manual adjustment of the display device. Furthermore, the image thumbnails of the professional profiles load independently of each other in a time staggered process and each thumbnail is an active link to the actual full profile page corresponding to the thumbnail view.

As mentioned above, FIG. 4 depicts an exemplary embodiment of a profile super wall 52 of the graphical user interface 110 of the live video communication platform of the present invention being displayed to the user 14 on the display device. The profile super wall 52 is a full screen visual overview of all the professional profiles on the platform whereby each professional profile is represented by a thumbnail that is an active link to the corresponding actual profile page. To browse, the user navigates through the thumbnails using the user input and control device 34. By hovering over a thumbnail with the user input and control device 34, a brief summary that includes, for example, the name, location, and tagline of the professional associated with the profile is displayed to the user 14. If the user 14 wishes to find out more detail about the professional, a click of the thumbnail will take the user directly to the full profile page of the professional associated with the selected thumbnail. To quickly narrow down the professional profiles shown in the profile super wall 52, the user 14 can select one or more parameter filters from a drop down menu 50 (e.g., filter by subject “category,” geographical “location,” “price” level, and type of “sessions” offered).

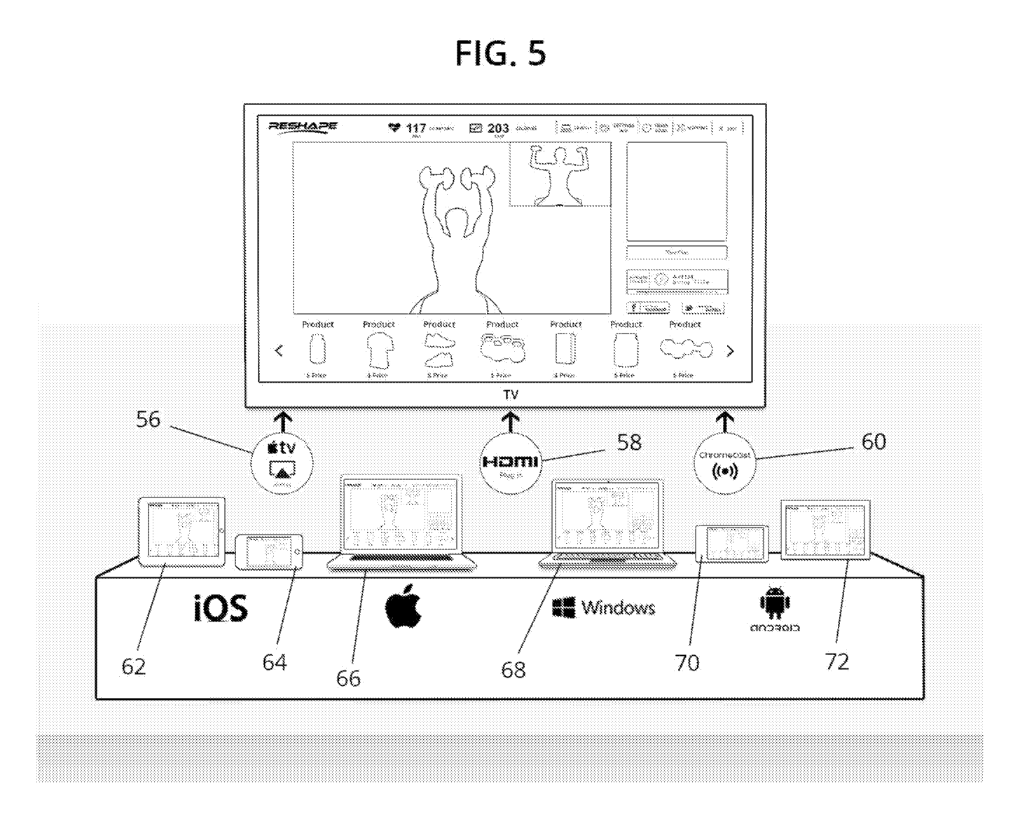

Referring now to FIG. 5, there is shown a graphical demonstration of the wide range of alternate methods and executing devices that can be interchangeably used, according to an exemplary embodiment of the present invention, to implement the interactive live video communication platform, but can also be operatively connected to a device having a larger screen size such as a television. This is achieved by first positioning any of the executing devices depicted in FIG. 5 within suitable proximity of the larger-screened device in order to operate the live video session using the smaller executing device's own video camera and microphone. Next, the output of the executing device's screen is mirrored onto the larger display device with various connection methods described further below to create a unified platform live interaction experience on the much larger screen.

For example, an executing device in the form of an iOS mobile device, such as an iPad 62 or an iPhone 64, can run a live video session with the native platform iOS software application of the interactive live video communication platform of the present invention in landscape mode. To mirror the display of the mobile device onto a television, the mobile device may be operatively connected to the television using, for example, an airplay feature 56 of an Apple TV device, a manufacture approved HDMI device plug 58, or a casting feature 60 that is built into a platform application and connects to a Google Chromecast device. In another example, these same connection mechanisms may serve to operatively connect an executing device that is an Apple Mac laptop 66 to the television wherein the laptop runs a live video session of the live video communication platform of the present invention through its web browser.

Similarly, a Microsoft Windows laptop 68 that is also capable of running a live video session of the interactive live video communication platform of the present invention through its web browser, may be operatively connected to the television using a manufacture approved HDMI device plug 58 or a casting feature 60 with a Google Chromecast device using a Google Chrome browser. These same connection mechanisms may also be employed to operatively connect an Andriod mobile device tablet 72 or smart phone 70 to a television, wherein these executing devices may run a live video session with the native platform Android software application of the interactive live video communication platform of the present invention in landscape mode.

Accordingly, the interactive live video communication platform of the present invention uniquely functions as a cross platform solution for any conventional television whereby a similar live video interaction experience is delivered with a variety of existing hardware types.

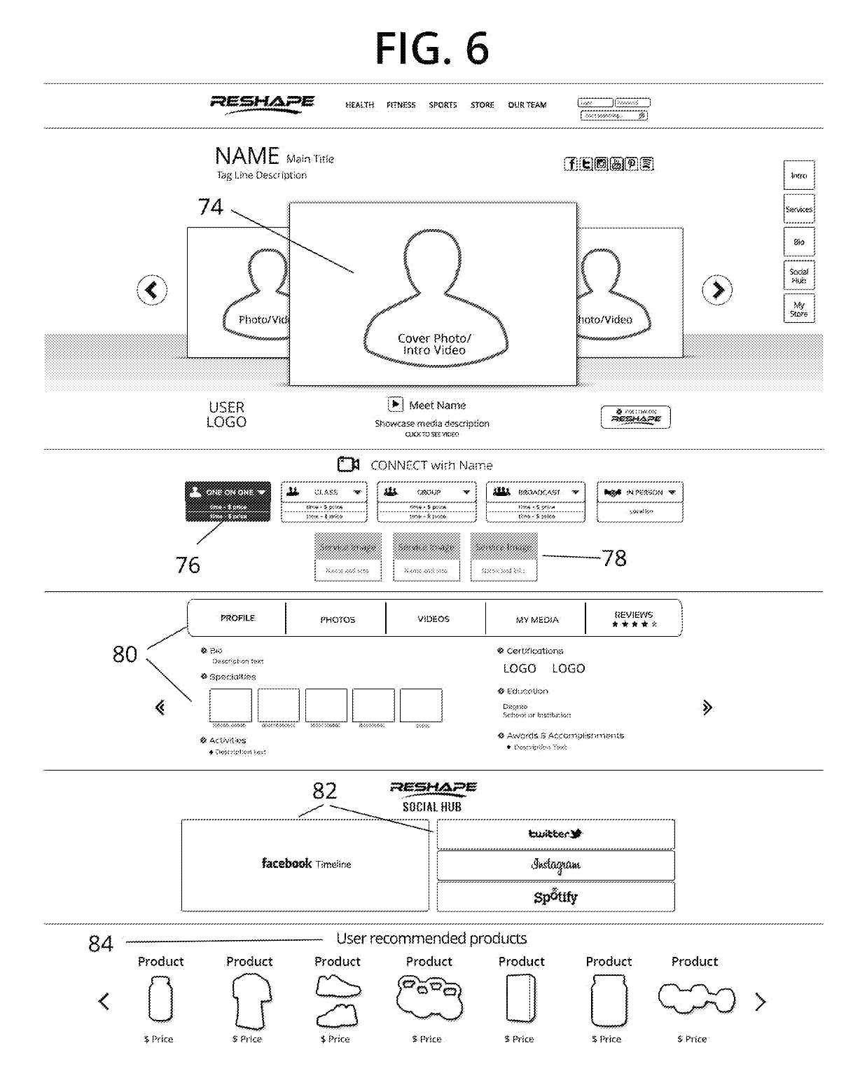

In FIG. 6, there is shown a schematic of an exemplary embodiment of a standard professional profile page of a graphical user interface 110 of the interactive live video communication platform of the present invention. The professional profile page has a unique design and functional features that are all standardized to be easily created, edited, and managed by the professional associated with the profile. The combination of elements of the professional profile provides a highly visual website-like experience in a single page in conjunction with the live video hosting and e-commerce solution aspects that are further described below.

For example, the showcase media carousel feature 74 of the professional profile page of FIG. 6 is a dynamic multimedia content holder that can contain an unlimited amount of media items (e.g., image or video) whereby each media item visually resides in a media content container of the carousel 74. The carousel 74 three dimensionally rotates the containers into view, forwards or backwards, by clicking on the associated navigational button(s) or dragging the containers by, for example, using the mouse feature of a user input and control device. Each media content container of the carousel 74 displays a cover image giving a glimpse of its content or, if the media content is a video that is hosted on, for example, YouTube®, the video may be displayed and directly played by clicking on the media content container. In addition, the profile creator may input a header and description text for each media content container that will display beneath the container when in view in the carousel 74. Accordingly, the carousel can be managed in such a way that it will display the professional's best content in a rotational manner so that videos and images can be logically presented and captioned without leaving the profile page.

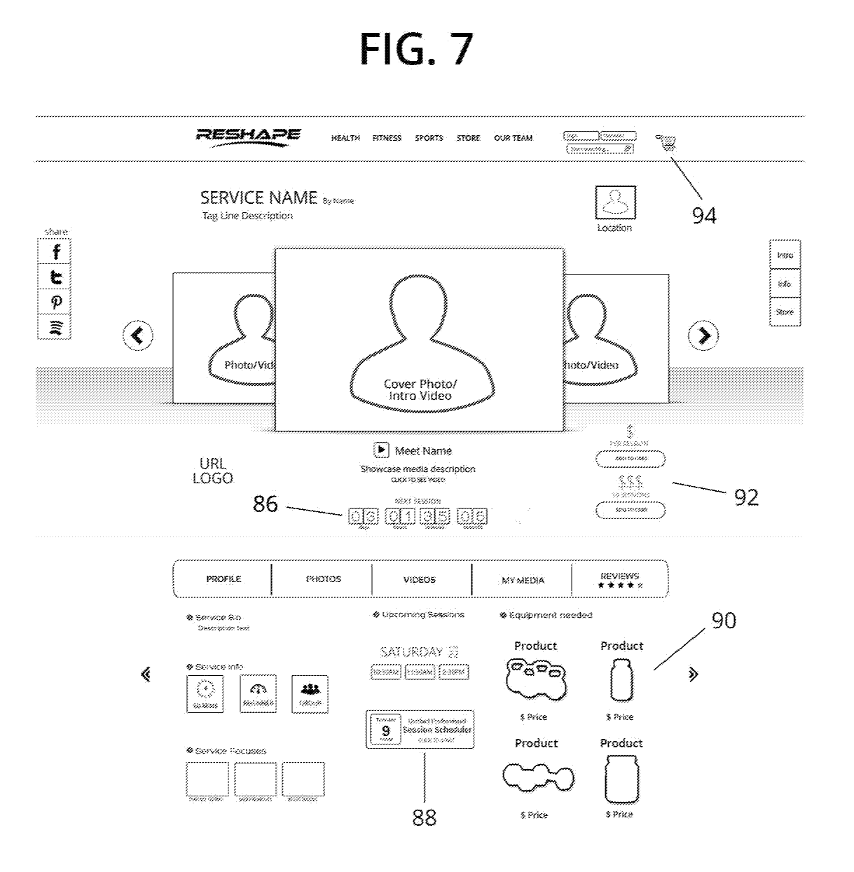

In the session service section 76 of the professional profile page of the exemplary embodiment of FIG. 6, each type of live video session that is offered by the associated professional is shown. In a drop down snapshot view, a dynamic pricing list for each session type that is being offered is displayed. When a user selects a particular session service category 76, all active session service widgets 78 within the selected session type are displayed. In other words, all of the upcoming sessions of the selected session type are shown to the user. Each service widget 78 shows an associated image, name, description and next upcoming date and time of each particular session of the selected session type that is scheduled. To navigate directly to the session page (described below with reference to FIG. 7) dedicated to a particular session, the user can simply click on the service widget 78 associated with that session.

In the profile information section 80 of the professional profile page of the exemplary embodiment of FIG. 6, the profile creator can dynamically display all pertinent information and media relevant to the field and services that are being offered by the associated professional. For advanced profile creators, menu tabs of this section can be edited and custom HTML content can be programmed and implemented within iFrames for a user to repurpose website assets in a standardized method.

Also provided on the professional profile page of FIG. 6 is a social media hub 82 that provides direct links to the social media accounts of the associated professional such that a viewer of the profile may interactively “like,” “share,” and/or “follow” the professional's social media account and/or comment directly on the platform profile page. These social media accounts are implemented in the user dashboard and unify the digital footprint of the professional such that all updates and posts to the social media accounts can be viewed all from one place (i.e., from the professional profile page of the platform).

Additionally, the recommended products section 84 of the professional profile page of FIG. 6 is a further example of the platform's personalized e-commerce solution whereby each participating professional can select specific products from the master online store provided by the platform and promote and offer the selected products for sale at the bottom of the professional's own profile page. All sales of the selected products are tracked with a unique profile ID and the professional associated with that ID receives an affiliate commission on all purchases that occur from the professional's profile page.

Turning to FIG. 7, there is shown an exemplary embodiment of a video service profile of a graphical user interface 110 of the interactive live video communication platform of the present invention. FIG. 7 demonstrates the interactive features of the method of scheduling and purchase. The next session countdown section 86 of the video service profile is automatically displayed when a session is actively scheduled thereby calling attention to the exact time left until the session is scheduled to occur. If a particular session is not being offered or is not available to the a user by a specific date and time, the session scheduler 88 of the video service profile, which is powered by a custom automated session request software of the live video communication platform of the present invention, allows a user to select alternative multiple dates and/or multiple times in one request to inquire as to the availability of the professional prior to purchasing the session. Accordingly, any sessions not already scheduled can be booked with the professional at a mutually agreeable date and time that falls within a user-specified period of time. In addition, on the video service profile, the associated professional may inform session attendees of the types of equipment 90 the professional selects as being necessary to participate in that particular session. The equipment 90 are products actively offered for sale on the platform and, therefore, a user can add the products to shopping cart 94 and purchase the products directly from the service profile prior to engaging in the session. This unique shopping and checkout feature of this video service profile allows a user to purchase both products 90 and services 92 of any type together.

Every type of profile object that comprises the platform, whether it be a professional profile, video service profile, or a corporate vendor or sponsor profile, are interconnected with and, therefore, can be interrelated to one another to form a dynamic and synchronous system. For example, a corporate vendor or sponsor may wish to promote an association between the corporation and a particular professional by functionally creating an interrelation between its profile and the profile of the professional.

b. Musical Performance Illustrative Example

In other illustrative examples, the live session that is being conducted by way of the interactive live video platform of the present invention is a live broadcasted sports or entertainment event whereby the user 14 is a spectator, fan, or other type of participant and is interacting with users in various locations that are also watching or participating in the live broadcasted event.

For example, the live session may be a musical performance or concert that is being streamed live in direct association with the live video communication platform of the present invention or in connection with a live streaming application that is developed by, or in association with, a third-party provider (e.g., Live Nation®) that is embedded within or is accessible through the live video communication platform of the present invention. Through a fan account supported by the live streaming application, user 14 can view a live feed of the musical performance or concert and, in an interactive two-way function of the live video communication platform, can display live video feed from the user's location (e.g., from the living room of the user's home) onto a display device located at the performance or concert venue, such as a “jumbo-tron,” to take part in the performance despite not being physically present there. Fan reactions at events on these big screens are a big part of the experience and create increased social engagement as well.

Many other interactive two-way functions during these types of performances are contemplated and made uniquely possible by the features of the live video communication platform of the present invention. For example, the performing musical artist may now personally engage fans for a promoted “meet-and-greet” or a “question-and-answer” session before, during, or after the live performance to drive viewership and/or increase pay-per-view revenue as fans will more likely participate for the chance to be selected to take part in these exclusive in-person sessions with the musical artist.

In addition, during the live interactive event, the musical artist's merchandise can be visually and verbally promoted and sold via the e-commerce functions of the live video communication platform of the present invention to users of the platform as they watch and engage in the live performance. Accordingly, the musical artist has a unique opportunity to further monetize the event in a way that is accessible to fans that could not attend the live performance.

c. Sporting Event Illustrative Example

In a further example, the live video communication platform of the present invention may be utilized to provide two-way interactive functions during sporting events being broadcasted live in direct association with the live video communication platform or in association with an embedded, or otherwise accessible, live streaming application that is developed by, or in association with, a third-party provider. In this particular industry, fan participation has become immensely popular due to the advent of social media outlets (e.g., Facebook® and Twitter®) and fantasy sports leagues, as well as the extensive commentary provided on journalistic television and in the print media. The live video communication platform of the present invention can provide interactive two-way interactions in which the athletes and commentators can engage fans who are watching the sports event from their own living rooms during, for example, a live “question-and-answer” session during a pregame, halftime, or postgame situation. The opportunity to be selected for engagement drives fan viewership and promotes continued or extended viewing of the programming as fans may be required to wait to determine if they are selected to participate in these interactive sessions.

Also, the live video communication platform of the present invention provides fans with the ability to interactively participate in trivia and gamification during the live sporting events.

Furthermore, merchandise associated with the sporting event (e.g., official team sportswear) may be promoted by a merchant and purchased by fans during the live sporting event using the e-commerce features of the live video communication platform of the present invention.

d. Film and Television Entertainment Illustrative Example

In another example, with respect to film or television entertainment programs that are screened or aired, the live video communication platform of the present invention may be utilized to provide two-way interactive functions amongst users before, during, or after the program has been screened or aired via a live stream in direct association with the live video communication platform or in association with an embedded, or otherwise accessible, live streaming application that is developed by, or in association with, a third-party provider. For example, an actor, actress, or director from the program may engage viewers in a variety of ways, including in an exclusive live “question-and-answer” session whereby a live feed of the viewer from his or her location (e.g., from the living room of the viewer's home) will be displayed along with the film or TV personality that they are getting to engage such that both sides of the interaction are visible to each other. Various methods can be used to promote these exclusive sessions. For example, if the film or television program is being aired on a cable broadcast channel, the associated network may work in conjunction with the cable provider to advertise in the provider's channel guide that the upcoming program will feature these live sessions to certain number of viewers whose user accounts will be chosen upon viewing the program.

Further, using the e-commerce features of the live video communication platform of the present invention, content providers can catalog and advertise items during TV shows and movies that can be offered as available products for purchase. A viewer can choose to have a product overlay feature turned “ON” to discreetly notify the viewer on his/her screen when a product is being offered or they can view the product store at the end of the programming that shows all the products they saw during the program. The content providers can also use an affiliate model of providing website links to online stores where these items can be purchased directly through the live video communication platform in real time. In this instance, these transactions are tracked and the content provider can receive an affiliate commission without handling fulfillment or inventory of these products.

The opportunity for a user account to be selected for engagement and the feature of purchasing products will make television entertainment content more valuable on a rental or purchase basis and would allow older television content to be monetized again if the actors and/or actresses from those programs can now interactively engage fans.

In addition, in instances in which the television program is a “talent show” whereby contestants exhibit or compete based upon their respective talents, the interactive two-way functions of the live video communication platform of the present invention allows television viewers to participate in these programs in ways they could not have before. For example, television viewers can participate in being part of the show, display their reactions to the contestant's performances and participate in interactive voting experiences that will drive advertising and brand recognition.

The foregoing description and accompanying drawings illustrate the principles, exemplary embodiments and particular modes of operation of the present invention. However, the present invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. A system for providing interactive live communication between at least two users remotely situated from each other, comprising:
at least one server having at least one processor and at least one computer-readable storage medium, the at least one computer-readable storage medium having computer program instructions configured to be executed by the at least one processor of the server;
a network communicatively coupled to the at least one server;
at least a first user and a second user that is remotely situated from the first user, each user having an executing multimedia device having:
at least one computer-readable storage medium;
a communication platform application stored in the at least one computer-readable storage medium, the communication platform application comprising a graphical user-interface through which users carry out all user-performed operations;
at least one processor communicatively coupled to the at least one computer-readable storage medium and configured to run the communication platform application;
at least one input device that captures in real time live video and audio data from the environment local to the user;
a network interface communicatively coupled to the network and that receives in real time from the network live video and audio data from at least one remote location; and
at least one output device that displays the graphical user-interface and outputs to the user, in real time and within the graphical user-interface, the live video and audio data received from the network; and
wherein the communication platform application:
receives via the network interface live video and audio data of a live event being conducted by the first user and, using the at least one output device, outputs in real time the received video and audio data to the first and second users;
transmits via the network interface live video and audio data comprising the second user's input in response to the live event and captured by the at least one input device and, using the at least one output device, outputs in real time the transmitted video and audio data to the first and second users to thereby establish live two-way interactive communication between at least the first and second users; and
using the graphical user-interface, displays during the live event to at least the second user, at least one item associated with the content of the live event.

2. The system according to claim 1, wherein the executing multimedia device is an interactive set-top box that is electrically coupled to a television and comprises:
at least one high-definition camera to capture video data from the surrounding environment;
at least one microphone to capture audio data from the surrounding environment;
at least one video output electrically connected to the television to output video data; and
at least one audio output electrically connected to at least one loudspeaker to output audio data.

3. The system according to claim 1, wherein the executing multimedia device is a personal computer comprising:
at least one high-definition camera to capture video data from the surrounding environment;
at least one microphone to capture audio data from the surrounding environment;
a display screen to output video data; and
at least one loudspeaker to output audio data.

4. The system according to claim 3, wherein the personal computer further comprises:
at least one video output configured to be electrically connected to a television to output video data; and
at least one audio output configured to be electrically connected to at least one external loudspeaker to output audio data.

5. The system according to claim 1, wherein the executing multimedia device is a mobile device comprising:
at least one high-definition camera to capture video data from the surrounding environment;
at least one microphone to capture audio data from the surrounding environment;
a display screen to output video data; and
at least one loudspeaker to output audio data.

6. The system according to claim 5, wherein the mobile device further comprises:
at least one video output configured to be electrically connected to a television to output video data; and
at least one audio output configured to be electrically connected to at least one external loudspeaker to output audio data.

7. The system according to claim 1, wherein the network interface is communicatively coupled to the network using at least one wireless link.

8. The system according to claim 1, further comprising at least one user remote control device communicatively coupled to the executing multimedia device and through which a user accesses, controls, and interacts with the communication platform application.

9. The system according to claim 1, further comprising:
a plurality of additional users, wherein:
each of the additional users is remotely situated from the first and second users and from each other; and
the communication platform application of the executing multimedia device of each of the additional users:
receives via the network interface the live video and audio data of the live event being conducted by the first user and, using the at least one output device, outputs in real time the received video and audio data to the additional user;
transmits via the network interface live video and audio data comprising the additional user's input in response to the live event and captured by the at least one input device and, using the at least one output device, outputs in real time the transmitted video and audio data to the first user and the additional user to thereby establish live two-way interactive communication between at least the first user and the additional user; and
using the graphical user-interface, displays during the live event to at least the additional user, at least one item associated with the content of the live event.

10. The system according to claim 9, further comprising:
a plurality of additional users, wherein:
each of the additional users is remotely situated from the first and second users and from each other;
the communication platform application of the executing multimedia device of each of the additional users:
receives via the network interface the live video and audio data of the live event being conducted by the first user and, using the at least one output device, outputs in real time the received video and audio data to the additional user;
transmits via the network interface live video and audio data comprising the additional user's input in response to the live event and captured by the at least one input device and, using the at least one output device, outputs in real time the transmitted video and audio data to the first and second users and the plurality of additional users to thereby establish live multi-way interactive communication between the first and second users and the plurality of additional users; and
using the graphical user-interface, displays during the live event to the second user and the plurality of additional users, at least one item associated with the content of the live event.

11. The system according to claim 1, wherein the second user purchases access to the live event using the communication platform application.

12. The system according to claim 1, wherein the at least one item associated with the content of the live event depicts a related product that can be purchased through the communication platform application.

13. The system according to claim 1, wherein the at least one item associated with the content of the live event is a text message from the first user.

14. The system according to claim 1, wherein the at least one item associated with the content of the live event is an informative indication regarding the second user's input in response to the live event.

15. The system according to claim 1, wherein the at least one item associated with the content of the live event is a playlist of music heard by the second user during the live event.

16. The system according to claim 1, wherein:
the first user is an industry professional;
the live event is an instructional session conducted by the first user and comprises visual and auditory instruction; and
the second user is an attendee of the instructional session.

17. The system according to claim 9, wherein:
the first user is an industry professional;
the live event is an instructional session conducted by the first user and comprises visual and auditory instruction; and
the second user and the plurality of additional users are attendees of the instructional session.

18. The system according to claim 16, wherein the communication platform application further comprises a search function whereby the second user can search for an industry professional that meets certain parameters that are specified by the second user using the graphical user-interface.

19. The system according to claim 16, wherein the communication platform application further comprises a professional profile that:
is associated with and customizable by the industry professional;
contains informative and promotional materials about the industry professional; and
is viewable by the second user through the graphical user-interface.

20. The system according to claim 19, wherein the professional profile further comprises:
a function in which the second user can schedule an instructional session; and
a function in which the industry professional can promote or recommend one or more products related to the instructional session.
